(19) United States
(12) Patent Application Publication
(10) Pub. No.: US 2019/0024509 A1
(43) Pub. Date: Jan. 24, 2019

(54) FEED APPARATUS AND METHOD FOR FEEDING CEMENT TO A CEMENT SILO

(71) Applicant: SANDVIK MINING AND CONSTRUCTION OY, Tampere (FI)

(72) Inventors: Sami JARVENTAUSTA, Tampere (FI); Jukka SIMILA, Tampere (FI); Tero YLI-HANNUKSELA, Tampere (FI)

(21) Appl. No.: 16/068,822

(22) PCT Filed: Jan. 12, 2017
(86) PCT No.: PCT/EP2017/050550

§ 371 Date: Jul. 9, 2018

(30) Foreign Application Priority Data
Jan. 20, 2016 (EP) 16152020.0

(51) Int. Cl. E21D 20/02; E21F 15/00; B65G 33/14

(52) U.S. Cl. CPC E21D 20/021; B65G 33/14; E21F 15/005

(57) ABSTRACT

A feed apparatus for feeding cement to a cement silo of a mining machine includes a receptacle for receiving cement, a transfer tube connected at a first end of the receptacle for guiding the cement from the receptacle to the cement silo connectable at a second end of the transfer tube and transfer means arranged in connection with the transfer tube and arranged to move cement within the transfer tube from the receptacle to the cement silo. The transfer tube includes at least one transfer tube section having a tube-like inner space for cement to be transferred.

### BACKGROUND

The invention relates to a feed apparatus and a method for feeding cement to a cement silo, more particularly to feeding cement to a cement silo attached to a mining machine.

In mining there are used grouting apparatuses both for grouting bolts in holes drilled for them and for injecting cement in holes or various fragmented rocks. Cement is usually fed from a lower part of a cement silo to a mixer, in which mixer the cement is mixed with water to produce grouting concrete. Typically, the cement silo is located on top of the mining machine, where it is relatively high up, whereby charging cement into the feed silo is hard, complicated and produces dust. Additionally, it often requires manual assistance especially in underground mines with limited space available requiring a separate working platform usually reached by a ladder and may even concern cement sacks being lifted by manpower, which all may further risk the occupational safety of the operators.

### BRIEF DESCRIPTION

An object of the present solution is to provide a new method and a feed apparatus for feeding cement to a cement silo of a mining machine for implementing the method. The objects of the solution are achieved by a method and a feed apparatus, which are characterized by what is stated in the independent claims. Some embodiments of the invention are disclosed in the dependent claims.

The solution is based on the idea of providing the feed apparatus with a receptacle, a transfer tube and transfer means arranged to move cement within the transfer tube from the receptacle to the cement silo. This enables selecting more freely the point at which the cement is fed to the mining machine. This is very beneficial, because the space in mining tunnels is typically very limited and because of the problems related to feeding the cement directly to the cement silo typically positioned on top of the mining machine can be avoided.

Some other advantages of the solution are discussed in connection with the detailed description.

### BRIEF DESCRIPTION OF THE DRAWINGS

In the following the invention will be described in greater detail by means of preferred embodiments with reference to the attached [accompanying] drawings, in which

FIG. 1 shows a mining machine comprising a feed apparatus for feeding cement to a cement silo with the feed apparatus in a tramming position;

FIG. 2 shows a mining machine comprising a feed apparatus for feeding cement to a cement silo with the feed apparatus in a use position;

FIG. 3 illustrates a method for supplying cement to a cement silo attached to a mining machine; and

FIGS. 4a and 4b illustrate schematically embodiments of a feed apparatus for a mining machine.

### DETAILED DESCRIPTION OF THE INVENTION

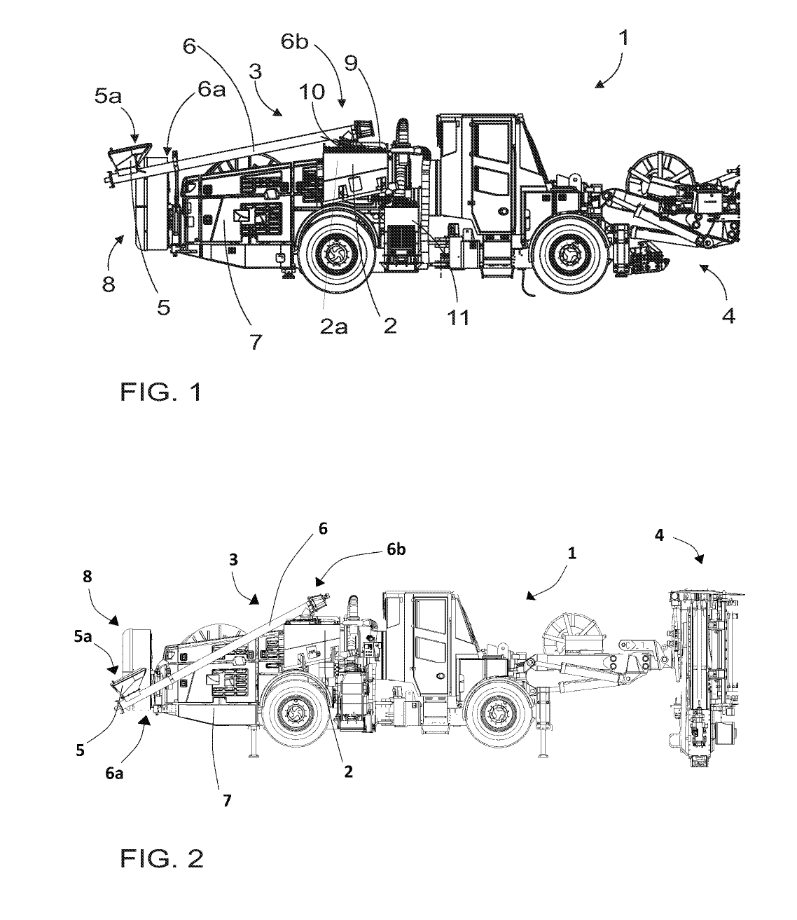

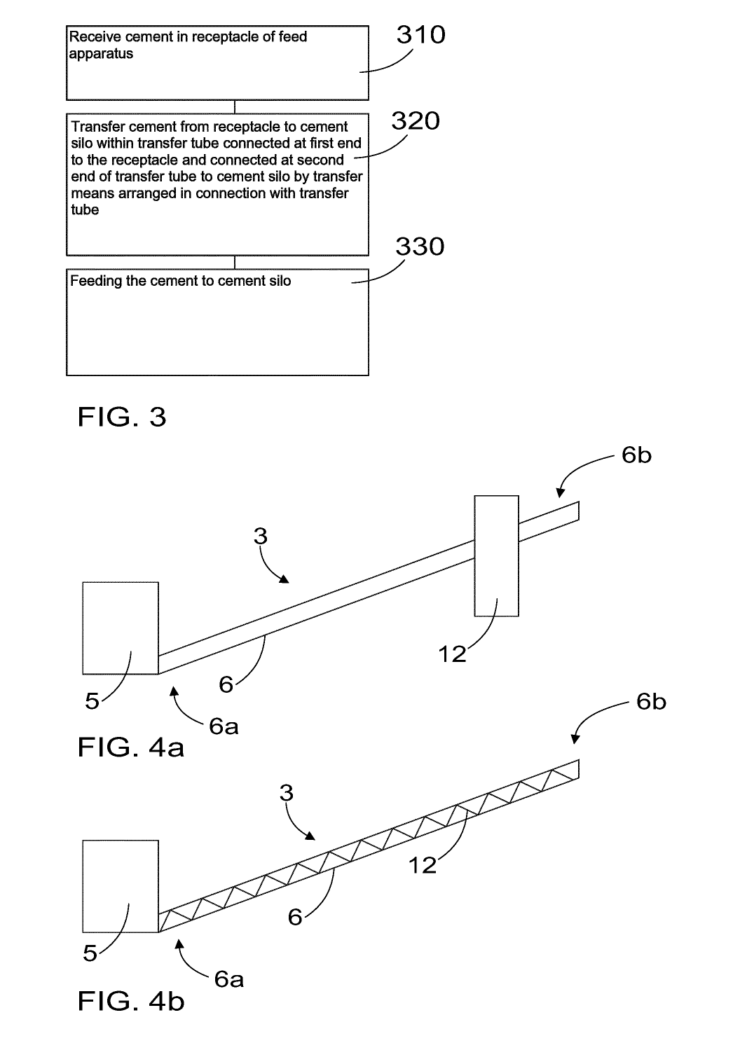

FIG. 1 shows a mining machine 1. The mining machine 1 may comprise any mining machine comprising means for providing grouting concrete to holes, splits and/or other cavities of a rock. Different embodiments such mining machines 1 and means 4 for providing grouting concrete in cavities provided in a rock are known as such. The mining machine 1 may also comprise a mixer 11 for mixing cement and water for producing the grouting concrete and a cement silo 2 through which the cement is fed to the mixer 11.

The mining machine 1 of FIG. 1 also comprises a feed apparatus 3 for feeding cement to the cement silo 2 of the mining machine 1. The feed apparatus 3 may comprise a receptacle 5 for receiving cement. According to an embodiment, the receptacle 5 may comprise a scoop-like container, wherein an opening 5a is arranged at the top of the receptacle 5 for receiving cement. This enables easy filling of the cement to the receptacle 5.

The feed apparatus 3 may further comprise a transfer tube 6 connected at a first end 6a to the receptacle 5 and connectable at a second end 6b to the cement silo 2 for guiding the cement from the receptacle 5 to the cement silo 2. The transfer tube 6 may be fixedly or removably attached to the receptacle 5 and/or the cement silo 2 for feeding cement to the cement silo 2. The transfer tube 6 may comprise at least one transfer tube section comprising a tube-like inner space for cement to be transferred. The transfer tube 6 enables positioning of the receptacle 5 for receiving cement at a desired position and, therefore, possibility for a more safe and convenient feeding of cement, as the cement does not need to be fed directly to the cement silo 2 or a receptacle provided above the cement silo 2.

According to an embodiment, the transfer tube 6 may comprise a transfer tube section and a connector part 6c for connecting the transfer tube 6 to the cement silo 2. According to another embodiment, the transfer tube 6 may further comprise a second transfer tube section. According to an embodiment, the transfer tube 6 may comprise at least two transfer tube sections arranged at an angle with respect to one another. These features enable more possible configurations and better fitting of the feed apparatus 3 with respect to the cement silo 2 and the frame part 7 of the mining machine 1.

According to an embodiment, at least a part of a transfer tube section of the transfer tube 6 may be formed as flexible at least in the transverse direction of the transfer tube section. The transverse direction of the transfer tube section may comprise a direction substantially perpendicular to the longitudinal direction of the transfer tube section. According to an embodiment, the at least part of the transfer tube section may be forms as flexible by the transfer tube section comprising a flexible material and/or a flexible structure.

According to an embodiment, the receptacle 5 may be provided as a fixed part of the feed apparatus 3. According to another embodiment, the receptacle 5 may comprise a separate unit that is removably arrangeable to the transfer tube 6. Different types of arrangements for removably arranging a receptacle to other structural parts are known as such and are not described here in more detail. In such embodiment, the receptacle 5 may be formed to be lifted to its use position by a fork-lift or other lifting apparatus known per se. Different types of lifting structures, such as lifting holes, lifting fixtures, lifting lugs, lifting hooks and the like are well known and are not described here in more detail.

The feed apparatus 3 may further comprise transfer means 12 arranged in connection with the transfer tube 6 and arranged to move cement within the transfer tube 6 from the receptacle 5 to the cement silo 2. The transfer means 12 may, thus, be arranged at least partly within the transfer tube 6 and/or at least partly surrounding at least one end of the transfer tube 6 or a point along the length of the transfer tube 6. According to an embodiment, the transfer means 12 may comprise a screw conveyor, such as it is schematically shown if FIG. 4b. In such an embodiment, the transfer means 12 may, thus, be arranged within the transfer tube 6. One benefit of such an embodiment is that it is cost efficient to provide. According to another embodiment, the transfer means 12 may comprise an ejector, such as is schematically shown in FIG. 4a. In such an embodiment, the transfer means 12 may, thus, be arranged at least partly surrounding a point along the length of the transfer tube 6 and in fluid connection with it. Ejectors refer to pneumatic conveyors where overpressure and/or underpressure is used to provide a force moving a material. In such an embodiment, for instance overpressure may be provided at the first end 6a and/or underpressure may be provided at the second end 6b, such that the pressure difference between the first end 6a and the second end 6b of the transfer tube 6 pushes or pulls the cement within the transfer tube 6 from the receptacle 5 to the cement silo 2. Ejectors and pneumatic conveyors as well as ways of providing overpressure and/or underpressure in connection with ejectors and pneumatic conveyors are known as such. The overpressure may be provided by some type of a blower and/or the underpressure may be provided by a suction compressor, for example. A benefit of such an embodiment is that it works well also with transfer tubes 6 that are not straight as shown in the figures but comprise tube sections arranged at an angle with respect to one another or comprise bends of some other type. According to a further embodiment, the transfer means may comprise any other apparatus and/or structure known per se and suitable for transferring cement inside a transfer tube also in an upwards inclined direction. These features further enhance the possibilities to position the feed apparatus 3 and especially the receptacle 5 for receiving the cement with respect to the mining machine 1, because the cement does not need to be fed to the cement silo 2 from above the cement silo 2, but the transfer means may convey the cement also in an upward or sideways direction. The feeding of the cement can, thus, be enabled in a more safe and convenient manner and also in more narrow and/or low mine tunnels. Also a need for a separate loading position and a use position of the receptacle 5 and/or the cement silo 2 can be avoided, which also supports feeding cement also during a use phase of the mining machine 1.

A feed apparatus 3 may be arrangeable in at least two alternative positions with respect to the mining machine 1, such as in a first position comprising a tramming position and a second position comprising a use position. FIG. 1 shows an embodiment of such a feed apparatus 3 shown in first position and FIG. 2 shows in a second position. The position of the receptacle 5 relative to a frame part 7 of the mining machine 1 in the tramming position may be closer to the midpoint of the mining machine 1 than in the use position in at least a vertical direction or a horizontal direction to optimise the overall dimensions of the mining machine. The position of the receptacle 5 relative to the frame part 7 of the mining machine 1 in the use position may similarly be located further away from the midpoint of the mining machine 1 than in the tramming position in at least a vertical direction or a horizontal direction to optimise the ease of feeding cement to the receptacle 5. According to an embodiment, the receptacle 5 may be provided in a use position lower and more to the side from the longitudinal centre line of the mining machine 1, whereby the receptacle 5 is easily available for feeding cement. In a tramming position with the receptacle 5 provided closer to the longitudinal centre line and higher up from the mine floor the mining machine 1 may require less space when tramming in the tunnels and the receptacle 5 is less exposed to impacts.

According to an embodiment, the feed apparatus 3 may further comprise lifting means (not shown) for moving at least the first end 6a of the transfer tube 6 relative to the frame part 7 of the mining machine 1 and thereby moving the feed apparatus 3 between the use position and the tramming position. According to an embodiment, the use position and the tramming position may comprise a use position and a tramming position as described above. According to an embodiment, the lifting means may comprise at least a pressure medium cylinder. Principles of such pressure medium cylinders are known as such and, thus, they are not explained in more detail.

According to an embodiment, the receptacle 5 is arranged in the vicinity of the back end 8 side of the mining machine 1. In other words, the receptacle 5 is arranged closer to the back end 8 of the mining machine 1, the back end 8 referring to the end of the mining machine 1 opposite to the end comprising means for providing grouting concrete.

A cement silo 2 according to the current solution may comprise a cover section 9 at the upper end of the cement silo 2 and at the cover section 9 a connecting part 10 shaped to be connected and sealed to a feed apparatus described in this description in a substantially dustproof manner. According to an embodiment, the transfer tube 3 may be connected and sealed to the connecting part 10 of the cover section 9. If the transfer tube 3 comprises a connector part 6c, the connector part 6c of the transfer tube 3 and the connecting part 10 of the cover section 9 of the cover section 9 of the cement silo 2 may be connected and sealed to one another. The sealing is not necessary in all circumstances, but it further decreases presence of dust in the air and, thus, improves the working conditions.

A method for supplying cement to a cement silo 2 attached to a mining machine 1 may comprise receiving 310 cement in a receptacle 5 of a feed apparatus 3. The method may further comprise transferring 320 the cement from the receptacle to the cement silo within a transfer tube connected at a first end to the receptacle and connected at a second end of the transfer tube to the cement silo by transfer means arranged in connection with the transfer tube, and feeding 330 the cement to the cement silo. The transfer tube 6 may comprise at least one transfer tube section comprising a tube-like inner space for cement to be transferred. Any feed apparatus 3 and/or a part thereof described in this description may be used in connection with the method.

According to an embodiment, the receptacle 5 may be provided at the back end 8 side of the mining machine 1 at least in a use position of the feed apparatus. The feed apparatus may be arranged in the use position of the feed apparatus 3 at least during a use phase of the mining machine 1, the use phase referring to a phase during operation of the mining machine 1. This use phase may comprise at least a phase during which cement is applied to the receptacle 5 of the feed apparatus 3. According to an embodiment, cement is supplied to the cement silo 2 during use of the mining machine 1. In other words, cement is supplied to the cement silo 2 simultaneously to providing grouting concrete to holes, splits and/or other cavities of a rock, for example. The use phase may, thus, also comprise providing grouting concrete to a rock.

According to an embodiment, the cement silo 2 comprises a sensor (not shown) for detecting the fill-level of the cement silo 2. The method for supplying cement to a cement silo 2 attached to a mining machine 1 may further comprise sensing the fill-level of the cement silo 2 and controlling automatically the transfer means of the feed apparatus 3, such that the volume of the cement fed by the transfer means is lowered or the function of the transfer means is stopped when a predetermined upper control limit of the fill-level of the cement silo 2 is exceeded and the volume of the cement fed by the transfer means is increased or the function of the transfer means is started when the fill-level of the cement silo 2 has fallen below a predetermined lower control limit. According to a further embodiment, the method may comprise sensing the fill-level of the cement silo 2 and giving a warning for an operator of the mining machine 1 when a predetermined upper control limit of the fill-level of the cement silo or a predetermined lower control limit of the fill-level of the cement silo controlling has been reached.

It will be obvious to a person skilled in the art that, as the technology advances, the inventive concept can be implemented in various ways. The invention and its embodiments are not limited to the examples described above but may vary within the scope of the claims.

1. A feed apparatus for feeding cement to a cement silo of a mining machine, the feed apparatus comprising:
a receptacle for receiving cement;
a transfer tube connected at a first end to the receptacle and arranged to guide the cement from the receptacle to the cement silo connectable to a second end of the transfer tube, the transfer tube having at least one transfer tube section including a tube-like inner space for cement to be transferred therethrough; and
a transfer device arranged in connection with the transfer tube and arranged to move cement within the transfer tube from the receptacle to the cement silo.

2. The feed apparatus according to claim 1, wherein the receptacle includes a scoop-like container, wherein an opening is arranged at the top of the receptacle for receiving cement.

3. The feed apparatus according to claim 1, wherein the transfer tube includes a transfer tube section and a connector part arranged to connect the transfer tube to the cement silo.

4. The feed apparatus as claimed in claim 1, wherein the transfer tube includes at least two transfer tube sections arranged at an angle with respect to one another.

5. The feed apparatus as claimed in claim 1, wherein at least a part of a transfer tube section is formed as flexible at least in the transverse direction of the transfer tube section by the transfer tube section including a flexible material and/or a flexible structure.

6. The feed apparatus as claimed in claim 1, wherein the transfer device is a screw conveyor.

7. The feed apparatus as claimed in claim 1, wherein the transfer means comprise device is an ejector.

8. The feed apparatus as claimed in claim 1, wherein the feed apparatus can be arranged in at least two alternative positions with respect to the mining machine, a first position being a tramming position and a second position being a use position, wherein the position of the receptacle relative to a frame part of the mining machine in the tramming position is closer to the midpoint of the mining machine than in the use position in at least a vertical direction or a horizontal direction to optimise overall dimensions of the mining machine, and wherein the position of the receptacle relative to the frame part of the mining machine in the use position is further away from the midpoint of the mining machine than in the tramming position in at least a vertical direction or a horizontal direction to optimise the ease of feeding cement to the receptacle.

9. The feed apparatus as claimed in claim 1, wherein the receptacle is arranged at the vicinity of a back end side of the mining machine.

10. A cement silo comprising:
a cover section at an upper end of the cement silo, wherein the cement silo includes at the cover section a connecting part shaped and arranged to be connected and sealed to a feed apparatus according to claim 1 in a dustproof manner.

11. A method for supplying cement to a cement silo attached to a mining machine, comprising:
receiving cement in a receptacle of a feed apparatus;
transferring the cement from the receptacle to the cement silo within a transfer tube connected at a first end to the receptacle and connected at a second end of the transfer tube to the cement silo by a transfer device arranged in connection with the transfer tube, the transfer tube including at least one transfer tube section having a tube-like inner space for cement to be transferred; and
feeding the cement to the cement silo.

12. The method according to claim 11, wherein the receptacle is provided at a back end side of the mining machine at least in a use position of the feed apparatus.

13. The method according to claim 11, wherein cement is supplied to the cement silo during use of the mining machine.

14. The method according to claim 11, wherein the cement silo includes a sensor for detecting the fill-level of the cement silo, wherein the method further comprises sensing a fill-level of the cement silo and controlling automatically the transfer device of the feed apparatus, such that the volume of the cement fed by the transfer device is lowered or the function of the transfer device is stopped when a predetermined upper control limit of the fill-level of the cement silo is exceeded and the volume of the cement fed by the transfer device is increased or the function of the transfer device is started when the fill-level of the cement silo has fallen below a predetermined lower control limit.

15. The method according to claim 11, wherein the cement silo includes a sensor for detecting a fill-level of the cement silo, wherein the method further comprises sensing the fill-level of the cement silo and giving a warning for an operator of the mining machine when a predetermined upper control limit of the fill-level of the cement silo or a predetermined lower control limit of the fill-level o the cement silo controlling has been reached.
